(19) United States
(12) Patent Application Publication
(10) Pub. No.: US 2008/0006298 A1
(43) Pub. Date: Jan. 10, 2008

(54) Means and method for cleaning drill bits

(76) Inventor: Adrian Teper, Vale Park (AU)

Correspondence Address: OSHA LIANG L.L.P., 1221 MCKINNEY STREET, SUITE 2800, HOUSTON, TX, 77010, US

(21) Appl. No.: 11/825,849

(22) Filed: Jul. 9, 2007

(30) Foreign Application Priority Data
Jul. 7, 2006 (AU) 2006903664

(51) Int. Cl. B08B 1/00; A46B 11/00; A46B 9/02

(52) U.S. Cl. 134/6; 15/104.92; 15/160

(57) ABSTRACT

This invention relates to an apparatus for cleaning working implements such as drill bits, and a method for using the same, the apparatus comprising a body supporting a plurality of bristles, the body being arranged and adapted so as to support these bristles in a position relative to a sidewall of a pail or bucket shaped container where each bristle extends inwardly of the sidewall of the container so that they will brush against a rotating rotary working implement inserted into the container.

### TECHNICAL FIELD

The present invention relates to an apparatus for cleaning working implements, particularly rotary working implements such as drill bits, and a method associated with this.

For the purposes of explanation, reference will be made to use of the present invention with respect to what are commonly referred to as mixing drill bits. It would be understood by those of ordinary skill in the art however that the invention is not limited to use with mixing drill bits, its application could instead extend to use on any rotating working implement.

### BACKGROUND ART

In this specification unless the contrary is expressly stated, where a document, act or item of knowledge is referred to or discussed, this reference or discussion is not to be construed as an admission that the document, act or item of knowledge or any combination thereof was at the priority date, publicly available, known to the public, part of common general knowledge; or known to be relevant to an attempt to solve any problem with which this specification is concerned.

Mixing drill bits are used in various trades to mix materials such as adhesives, paints and renders in readiness for their application.

At present, these mixing drill bits are ‘rinsed’ by leaving them in a bucket of water when they are not in use. A problem with this is that it rarely removes all of the material from the tool, and over time this material builds up, reducing the effectiveness of the tool, making the tool harder to drive.

Alternatively, one can wait until the tool is covered in dried material, and then attempt to remove this by chiseling it off, but this is laborious and time consuming.

It is an object of the present invention therefore to provide an apparatus for cleaning working implements such as drill bits, that substantially overcomes the aforementioned difficulties, or at the least provides a useful alternative to the presently used methods for cleaning these working implements.

Other objects and advantages of the present invention will become apparent from the following description, taken in connection with the accompanying drawings, wherein, by way of illustration and example, an embodiment of the present invention is disclosed.

For the purpose of this specification the word “comprising” means “including but not limited to”, and the word ‘comprises’ has a corresponding meaning.

### DISCLOSURE OF THE INVENTION

In one form of this invention there is proposed an apparatus for cleaning working implements such as drill bits comprising a body supporting a plurality of bristles, the body being arranged and adapted so as to support these bristles in a position relative to a sidewall of a pail or bucket shaped container where each bristle extends inwardly of the sidewall of the container so that they will brush against a rotating rotary working implement inserted into the container.

Preferably, the body of the apparatus is the container, and the bristles extend inwardly from the sidewall of the container.

Preferably, the inner sidewall of the container is substantially covered in inwardly directed bristles.

Preferably in an alternative, the body of the apparatus is a sheet of flexible material supporting the bristles so that they extend from a side thereof.

In a further form, the invention may be said to reside in method for cleaning a working implement using an apparatus as defined in the preceding paragraph, the method comprising the steps of rolling the sheet of flexible material into a ring or tube having a pair of opposing open ends where the bristles are directed inwardly, placing this tube into the container so that one open end of the tube rests against the bottom of the container, and then inserting a rotating rotary working implement into the container so that this rotates against the bristles.

Preferably in an alternative, the body of the apparatus has a ring or tube shape tube having a pair of opposing open ends, the body supporting the bristles so that these extend inwardly of the ring or tube.

In a further form, the invention may be said to reside in method for cleaning a working implement using an apparatus as defined in the preceding paragraph, the method comprising the steps of placing this tube into the container so that one open end of the tube rests against the bottom of the container, and then inserting a rotating rotary working implement into the container so that this rotates against the bristles.

Preferably, in an alternative, the body of the apparatus is a rigid member further comprising positioning means adapted to secure the body to a sidewall of the container.

In a further form, the invention may be said to reside in a method for cleaning a working implement using an apparatus as defined in the preceding paragraph, the method comprising the steps of securing the rigid body to a sidewall of the container using the positioning means, and then inserting a rotating rotary working implement into the container so that this rotates against the bristles.

Preferably, the positioning means adhere the rigid member to the sidewall of the container.

Preferably, in an alternative, the positioning means secures the rigid member to the sidewall of the container with a clamping action.

Preferably, the working implement is a mixing drill bit.

Preferably, the container is at least partially filed with a liquid.

Preferably, the liquid is water.

Preferably, the apparatus further comprises means for supporting a drill retaining the drill bit in a position where it can rotate against the bristles.

Preferably, the means for supporting the drill is a cradle.

Preferably, the drill and drill bit are supported to that the drill can turn the bit in the container or conduit without the bit contacting the inner wall of the container or conduit.

Preferably, the container is a bucket.

### BRIEF DESCRIPTION OF THE DRAWINGS

For a better understanding of this invention it will now be described with respect to one or more embodiments which shall be described herein with the assistance of drawings wherein;

FIG. 1 is a perspective view of the apparatus according to a first embodiment;

FIG. 2 is a cross-sectioned perspective view of the apparatus in FIG. 1;

FIG. 3 is a perspective view of an apparatus according to a further form of the invention;

FIG. 4 is a cross-sectioned perspective view of the apparatus in FIG. 3;

FIG. 5 is a perspective view of an apparatus according to a further form of the invention;

FIG. 6 is a top view of a bucket illustrating the apparatus in FIG. 5;

FIG. 7 is a cross-sectional view through a bucket illustrating an apparatus according to a further form of the invention; and

FIG. 8 is a cross-sectional view through a bucket illustrating yet a further form of the invention.

### DETAILED DESCRIPTION OF THE INVENTION

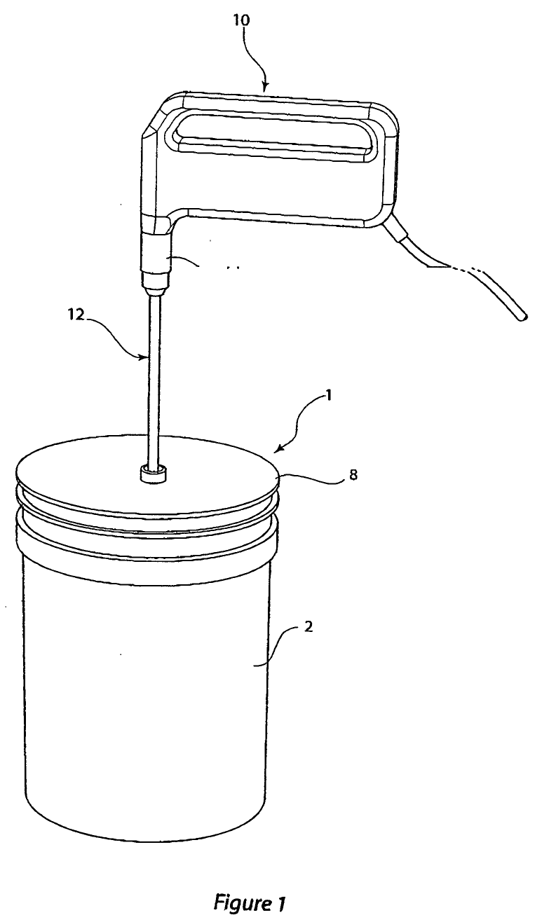

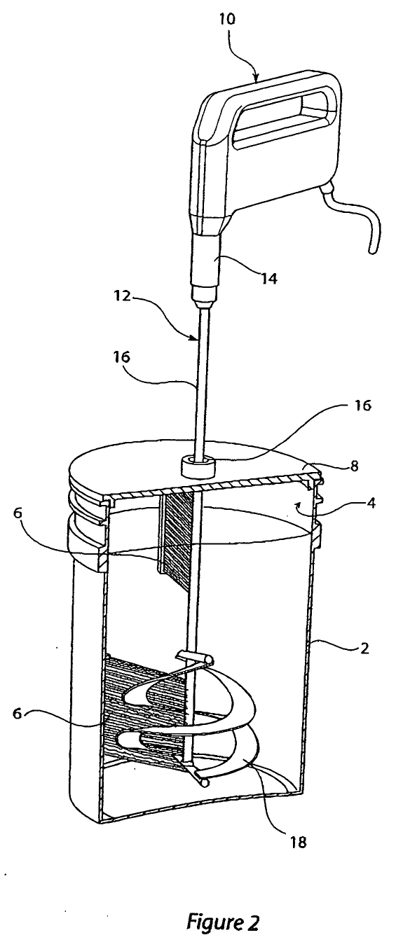

Referring now to the illustrations, and in particular to FIGS. 1 and 2, where there is illustrated an apparatus 1 for cleaning working implements such as drill bits, comprising a partially filled bucket 2 of water, the inner wall 4 of the bucket 2 supporting a plurality of inwardly directed bristles 6 such that the inner wall 4 is completely covered by these inwardly extending bristles 6. In FIGS. 1 and 2 however, not all of these bristles 6 have been illustrated, in order to permit visibility.

It would be understood by a person skilled in the art however, that the bristles may be positioned in only specific locations as dictated by the nature and dimensions of the drill bit to be cleaned.

Separate to the bucket 2 but removably seated in its opening is a cradle 8 supporting an electric drill 10, which in turn is retaining a mixing drill bit 12 in its chuck 14. This mixing drill bit 12 comprises a shank 16 and an auger shaped portion 18, and it is used to mix tiling cement prior to application of the cement.

The cradle 8 supports the drill 10 so that the drill bit 12 passes through the opening and down into the bucket 2, so that the bit 12 is surrounded by and in contact with the bristles 6, and so that the drill 10 can turn the bit 12 in the bucket 2 without the bit contacting the inner wall 4 or floor of the bucket 2.

The apparatus may be used without the cradle 8, but this means that a person must support the drill whilst it is running.

The drill 10 can then be set to a low speed and switched on. The drill 10 will then turn the bit 12 against the brushes 6, which will cause material adhering to both the shank 16 and auger 18 of the bit 12 to be dislodged and settle to the bottom of the bucket 2.

In trials conducted to date the apparatus described herein has proved to be extremely effective at cleaning mixing drill bits 12 used for mixing tiling cement.

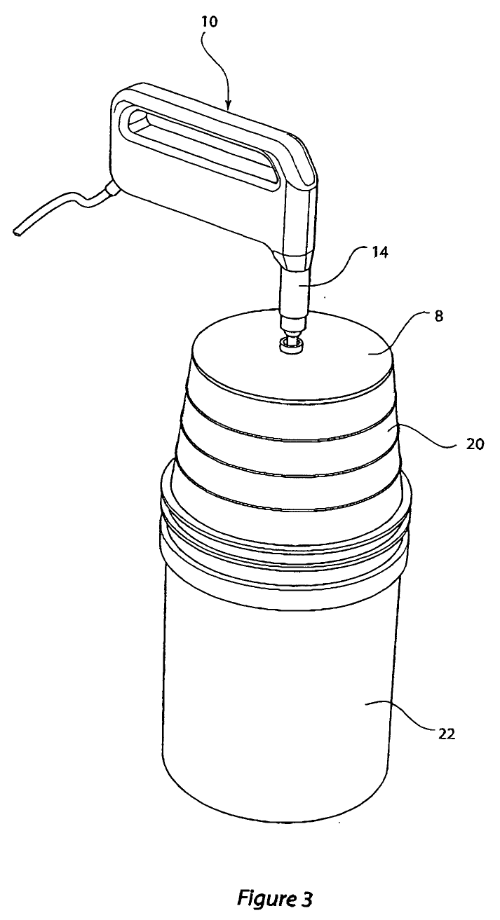

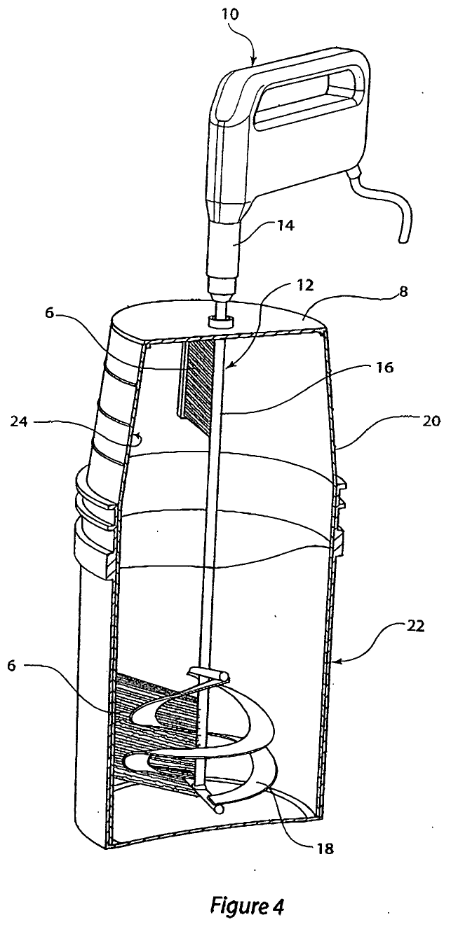

Referring now to FIGS. 3 and 4, there is a sleeve 20 having the shape of an elongate tube, which is adapted to be removably positioned in a regular bucket 22 (i.e. a bucket not lined with bristles). The inner wall 24 of the sleeve supports a plurality of inwardly directed bristles such that the inner wall is completely covered by these inwardly extending bristles. The apparatus works identically to the embodiment discussed above, except for the fact that the sleeve 20 and the bucket 22 can be separated for cleaning.

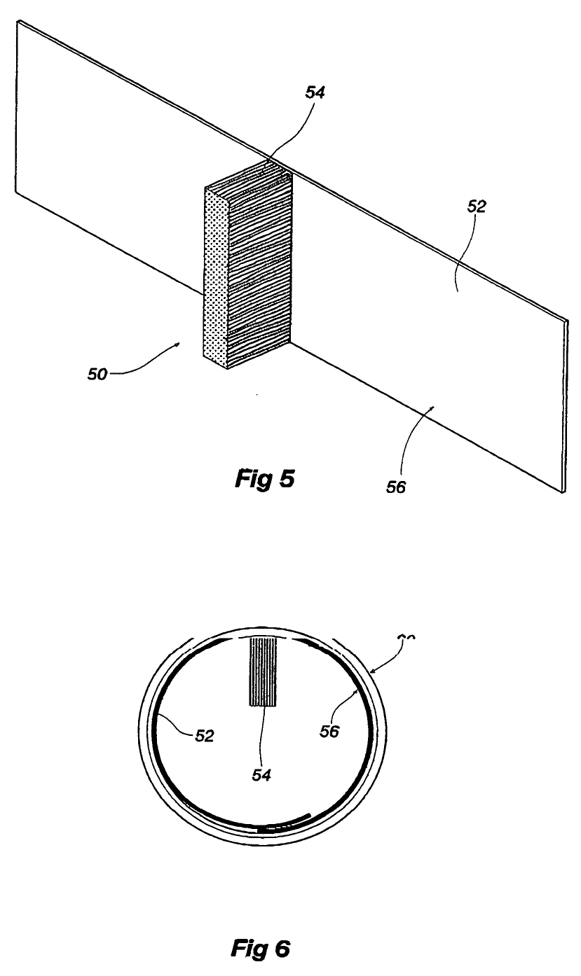

Referring now to FIG. 5, where the apparatus 50 incorporates a sheet of flexible material 52 supporting the bristles 54 so that they extend from a side thereof.

In use, the sheet of flexible material 52 is rolled into a tube having a pair of opposing open ends where the bristles 54 are directed inwardly, and this tube is then placed into the container 60 so that one open end of the tube rests against the bottom of the container. The tube then is able to unwind to an extent that the outer, non-bristled side of the sheet of flexible material is biased against the inside wall of the container 60, as illustrated in FIG. 6. The rotating rotary working implement is then inserted into the container so that this rotates against the bristles.

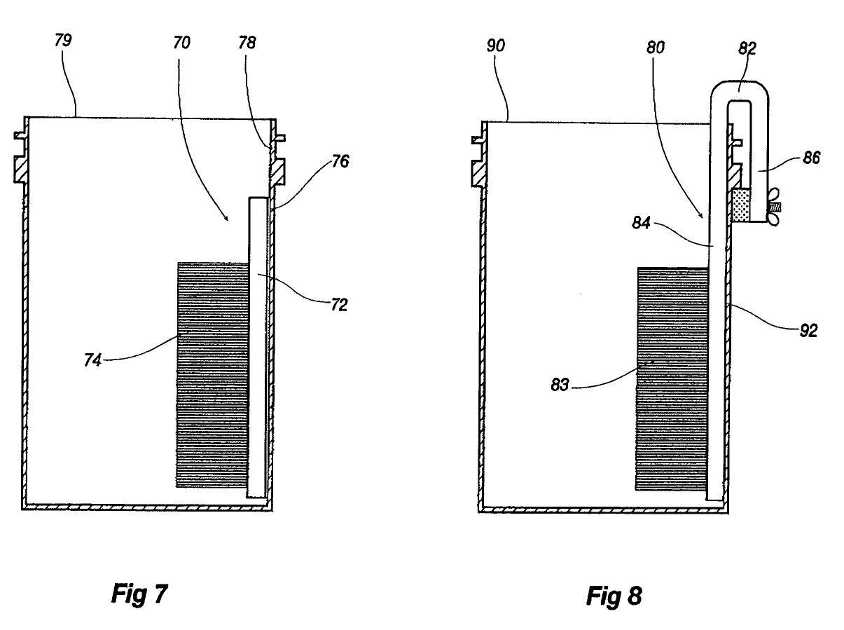

Referring now to FIG. 7, where the apparatus 70 has rigid body 72 supporting the bristles 74, and where the rigid body 72 has an adhesive backing 76 that allows is to be stuck to the inner sidewall 78 of the container 79.

Referring now to FIG. 8, where the apparatus 80 again has a rigid body 82 supporting bristles 83, the rigid body in this instance having first 84 and second 86 portions that clamp around the sidewall 92 of the container 90 so as to fix the apparatus 80 in position.

It is considered then that this embodiment would be easier to clean that the abovementioned embodiment.

It is considered that the method and apparatus according to the present invention would be of particular use to those who use mixing drill bits to prepare adhesives, paints and renders.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

The claims defining the invention are as follows:

1. An apparatus for cleaning working implements such as drill bits comprising a body supporting a plurality of bristles, the body being arranged and adapted so as to support these bristles in a position relative to a sidewall of a pail or bucket shaped container where each bristle extends inwardly of the sidewall of the container so that they will brush against a rotating rotary working implement inserted into the container.

2. The apparatus as in claim 1, wherein the body of the apparatus is the container, and the bristles extend inwardly from the sidewall of the container.

3. The apparatus as in claim 2, wherein the inner sidewall of the container is substantially covered in inwardly directed bristles.

4. The apparatus as in claim 1, wherein the body of the apparatus is a sheet of flexible material supporting the bristles so that they extend from a side thereof.

5. A method for cleaning a working implement using an apparatus as defined in claim 4, comprising the steps of rolling the sheet of flexible material into a ring or tube having a pair of opposing open ends where the bristles are directed inwardly, placing this tube into the container so that one open end of the tube rests against the bottom of the container, and then inserting a rotating rotary working implement into the container so that this rotates against the bristles.

6. The apparatus as in claim 1, wherein the body of the apparatus has a ring or tube shape tube having a pair of opposing open ends, the body supporting the bristles so that these extend inwardly of the ring or tube.

7. A method for cleaning a working implement using an apparatus as defined in claim 6, comprising the steps of placing this tube into the container so that one open end of the tube rests against the bottom of the container, and then inserting a rotating rotary working implement into the container so that this rotates against the bristles.

8. The apparatus as in claim 1, wherein the body of the apparatus is a rigid member further comprising positioning means adapted to secure the body to a sidewall of the container.

9. The apparatus as in claim 8, wherein the positioning means adhere the rigid member to the sidewall of the container.

10. The apparatus as in claim 8, wherein the positioning means secures the rigid member to the sidewall of the container with a clamping action.

11. A method for cleaning a working implement using an apparatus as defined in claim 8, comprising the steps of securing the rigid body to a sidewall of the container using the positioning means, and then inserting a rotating rotary working implement into the container so that this rotates against the bristles.

12. The apparatus as in claim 1, wherein the working implement is a mixing drill bit.

13. The apparatus as in claim 1, wherein the container is at least partially filed with a liquid.

14. The apparatus as in claim 1, wherein the liquid is water.

15. The apparatus as in claim 1, wherein the apparatus further comprises means for supporting a drill retaining the drill bit in a position relative to the apparatus and or container where it can rotate against the bristles.

16. The apparatus as in claim 15, wherein the means for supporting the drill is a cradle.
